(19) United States
(12) Patent Application Publication
(10) Pub. No.: US 2013/0141508 A1
(43) Pub. Date: Jun. 6, 2013

(54) METHOD OF MANUFACTURING THERMAL HEAD, AND THERMAL PRINTER AND METHOD OF DRIVING THE SAME

(71) Applicant: Seiko Instruments Inc., Chiba-shi (JP)

(72) Inventors: Noriyoshi SHOJI, Chiba-shi (JP); Norimitsu SANBONGI, Chiba-shi (JP); Keitaro KOROISHI, Chiba-shi (JP); Toshimitsu MOROOKA, Chiba-shi (JP); Takao AKIYAMA, Chiba-shi (JP)

(73) Assignee: SEIKO INSTRUMENTS INC., Chiba-shi (JP)

(21) Appl. No.: 13/680,937

(22) Filed: Nov. 19, 2012

(30) Foreign Application Priority Data
Dec. 1, 2011 (JP) 2011-263774

(51) Int. Cl. B41J 2/335

(52) U.S. Cl. CPC B41J 2/3359; B41J 2/33515
USPC 347/206; 29/611

(57) ABSTRACT

A method of manufacturing a thermal head, comprising the steps of: bonding a support substrate and an upper substrate, which have a flat shape, together in a laminated state, the support substrate and the upper substrate having opposed surfaces, at least one of which includes a heat-insulating concave portion; thinning the upper substrate bonded onto the support substrate in the bonding step; measuring a thickness of the upper substrate thinned in the thinning step; forming an identifying resistor having a resistance value varied in accordance with the thickness of the upper substrate measured in the measurement step, the identifying resistor including one end grounded; and forming a heating resistor on a surface of the upper substrate thinned in the thinning step at a position opposed to the heat-insulating concave portion.

### RELATED APPLICATIONS

This application claims priority under 35 U.S.C. §119 to Japanese Patent Application No. 2011-263774 filed on Dec. 1, 2011, the entire content of which is hereby incorporated by reference.

### BACKGROUND OF THE INVENTION

1. Field of the Invention

The present invention relates to a method of manufacturing a thermal head, and a thermal printer and a method of driving the same.

2. Description of the Related Art

As a method of manufacturing a thermal head to be used in a thermal printer, an opening portion is formed in one surface of a support substrate and an upper substrate is bonded onto the support substrate in a laminated state so as to close the opening portion. Then, a heating resistor is formed on a surface of the upper substrate at a position opposed to the opening portion across the upper substrate, and then a protective film is formed to cover the heating resistor and the surface of the upper substrate, to thereby manufacture a thermal head having a cavity portion formed therein between the support substrate and the upper substrate.

In this case, a resistance value of the heating resistor is adjusted based on a thickness dimension of the upper substrate, and hence it is possible to easily manufacture a highly-efficient thermal head capable of accurately outputting a target heating amount that takes into account the amount of heat which is not utilized and wasted.

In the above-mentioned manufacturing method, the thickness dimension of the upper substrate is divided into sections at predetermined intervals, and a database that stores the resistance value of the heating resistor in association with each section is prepared. After the thickness dimension of the upper substrate is measured, the resistance value of the heating resistor corresponding to the measured thickness dimension is read from the database, and the resistance value of the heating resistor is adjusted.

However, the adjustment of the resistance value of the heating resistor needs to be performed with a voltage pulse or laser light, and hence there is a disadvantage that a manufacturing process is complicated to increase manufacturing cost.

Therefore, in this field, a method of manufacturing a thermal head, and a thermal printer and a method of driving the same which are capable of suppressing a variation in heating efficiency caused by a variation in thickness of the upper substrate easily at low cost have been sought after.

### SUMMARY OF THE INVENTION

According to an exemplary embodiment of the present invention, there is provided a method of manufacturing a thermal head, including: bonding a support substrate and an upper substrate, which have a flat shape, together in a laminated state, the support substrate and the upper substrate having opposed surfaces, at least one of which includes a heat-insulating concave portion; thinning the upper substrate bonded onto the support substrate in the bonding; measuring a thickness of the upper substrate thinned in the thinning; forming an identifying resistor having a resistance value varied in accordance with the thickness of the upper substrate measured in the measuring, the identifying resistor including one end grounded; and forming a heating resistor on a surface of the upper substrate thinned in the thinning at a position opposed to the heat-insulating concave portion.

According to this exemplary embodiment, in the bonding step, the upper substrate and the support substrate are bonded together to close the heat-insulating concave portion, to thereby form a cavity portion between the upper substrate and the support substrate. The cavity portion functions as a hollow heat-insulating layer for insulating heat transferred from the upper substrate side to the support substrate side. Then, in the thinning step, the upper substrate is thinned, to thereby reduce a heat capacity of the upper substrate.

After that, in the resistor forming step, the heating resistor is formed on the surface of the upper substrate at the position opposed to the opening portion. Of the amount of heat generated by the heating resistor, an amount of heat that dissipates to the upper substrate side is suppressed by the thinning of the upper substrate and the heat insulation of the cavity portion. Thus, the available amount of heat can be increased.

In this case, the available amount of heat depends on the resistance value of the heating resistor and the thickness of the upper substrate. Therefore, the thickness of the thinned upper substrate is measured in the measurement step, and the identifying resistor having a resistance value varied in accordance with the measured thickness is formed in the identifying resistor forming step. With this configuration, the resistance value of the identifying resistor can be detected easily from the side of the thermal printer in which the thermal head is mounted.

Specifically, for example, when a power source is connected to a non-grounded terminal of the identifying resistor via a reference resistor having a known resistance value, a power supply voltage is divided by the identifying resistor and the reference resistor. Therefore, by measuring a voltage at a connection portion between the identifying resistor and the reference resistor, the resistance value of the identifying resistor can be detected easily on the thermal printer side. If the resistance value of the identifying resistor can be detected on the thermal printer side, the thickness of the upper substrate, that is, the heating efficiency can be recognized on the thermal printer side. Thus, a voltage to be applied to the thermal head can be compensated for accurately so that printing density is not varied.

In the above-mentioned exemplary embodiment, the forming an identifying resistor may include: forming a thin film as a linear resistor piece which has a predetermined resistance value; and forming an identifying concave portion in a region to be crossed by the linear resistor piece, the identifying concave portion being recessed from the surface of the upper substrate with a pattern varied in accordance with a group of the thickness of the upper substrate measured in the measuring, the forming an identifying concave portion preceding the forming a thin film.

With this configuration, in the identifying concave portion forming step, the identifying concave portion is formed in the surface of the upper substrate with a pattern varied in accordance with the group of the thickness of the upper substrate. As used herein, the group of the thickness of the upper substrate means that a plurality of predetermined thickness ranges are provided. Further, the pattern varied in accordance with the group means that the pattern of the identifying concave portion is switched depending on which of the groups the measured thickness of the upper substrate belongs to. A pattern having no identifying concave portion is also one of the patterns.

Then, in the case where the pattern having the identifying concave portion is formed, when a film of the resistor piece is formed so as to cross the identifying concave portion in the film-forming step, such a linear resistor piece made of a thin film is cut by steps formed at boundaries between the surface of the upper substrate and the identifying concave portion, and hence a resistance value of this resistor piece becomes infinite (disconnection caused by steps). On the other hand, in the case where the pattern having no identifying concave portion is formed, when a film of the resistor piece is formed so as to cross the identifying concave portion in the film-forming step, such a linear resistor piece made of a thin film is formed on the surface of the upper substrate continuously without being cut, and hence a resistance value of this resistor piece becomes a predetermined designed resistance value.

That is, if the identifying concave portion having a pattern varied in accordance with the group of the thickness of the upper substrate is formed in the identifying concave portion forming step, merely by thereafter performing the film-forming step of forming the identifying resistor having exactly the same configuration, the identifying resistor having a resistance value varied in accordance with the group of the thickness of the upper substrate can be formed easily. In particular, the identifying concave portion is formed before the formation of the identifying resistor, and hence it is possible to prevent dust or the like that is generated during processing of the identifying concave portion from adhering to the identifying resistor or other portions.

Further, in the above-mentioned exemplary embodiment, the forming a thin film may include forming the linear resistor pieces having substantially the same resistance value in parallel in a number smaller than a number of the groups of the thickness of the upper substrate by at least one.

With this configuration, when the number of the groups of the thickness of the upper substrate is, for example, five, four resistor pieces are formed in parallel. With this, five kinds of thicknesses of the upper substrate can be recognized from the outside based on a total of five kinds of patterns of the identifying concave portions, that is, a pattern having no identifying concave portion and patterns in which the identifying concave portion(s) is formed in a region(s) crossed by one to four resistor pieces.

Further, in the above-mentioned exemplary embodiment, the forming a thin film and the forming a heating resistor may be performed simultaneously.

With this configuration, the film-forming step is performed simultaneously with the heating resistor forming step to reduce the number of steps. Thus, the thermal head can be manufactured at low cost.

Further, in the above-mentioned exemplary embodiment, the method of manufacturing a thermal head may further include forming a through hole in the upper substrate thinned in the thinning, the through hole passing through the upper substrate in a thickness direction of the upper substrate, and the measuring may include measuring a depth of the through hole formed in the forming a through hole.

Further, according to another exemplary embodiment of the present invention, there is provided a thermal printer, which is connected to a thermal head manufactured by the method of manufacturing a thermal head having any one of the above-mentioned configurations, the thermal printer including a detection circuit for detecting a resistance value of an identifying resistor included in the thermal head.

The above-mentioned thermal printer may further include a control section for controlling a current to be supplied to the thermal head in accordance with the resistance value of the identifying resistor detected by the detection circuit.

Further, according to another exemplary embodiment of the present invention, there is provided a method of driving a thermal printer, including controlling a current to be supplied to the thermal head in accordance with the resistance value of the identifying resistor detected by the detection circuit.

According to each of the above-mentioned exemplary embodiments of the present invention, there is an effect that the variation in heating efficiency caused by the variation in thickness of the upper substrate can be suppressed easily at low cost.

### BRIEF DESCRIPTION OF THE DRAWINGS

In the accompanying drawings:

FIG. 1 is a schematic cross-sectional view of a thermal printer including a thermal head manufactured by a method of manufacturing a thermal head according to a first embodiment of the present invention;

FIG. 2 is a flowchart of the method of manufacturing a thermal head according to the first embodiment of the present invention;

FIG. 3 is a plan view of the thermal head of FIG. 1 as seen from a protective film side;

FIG. 4 is a vertical cross-sectional view of the thermal head of FIG. 3 orthogonal to a longitudinal direction thereof;

FIG. 5 is a schematic cross-sectional view illustrating how to measure a thickness of an upper substrate of the thermal head of FIG. 3;

FIG. 6 is a flowchart illustrating a formation step in the method of manufacturing a thermal head of FIG. 2;

FIG. 7 is a flowchart illustrating a resistor forming step in the formation step of FIG. 6;

FIG. 8 is a plan view illustrating an example of an identifying resistor included in the thermal head of FIG. 1;

FIG. 9 is a vertical cross-sectional view of the identifying resistor of FIG. 8;

FIG. 10 is a table showing an example of groups of the thickness of the upper substrate used in a first step of the resistor forming step of FIG. 7;

FIGS. 11A to 11D are plan views illustrating patterns of the identifying resistor in accordance with the groups stored in the table of FIG. 10;

FIG. 12 is a diagram illustrating the identifying resistor of FIG. 9 and a detection circuit provided on the thermal printer side for detecting a resistance value of the identifying resistor;

FIG. 13 is a flowchart illustrating a modified example of the method of manufacturing a thermal head of FIG. 2; and

FIG. 14 is a vertical cross-sectional view of a thermal head manufactured by the manufacturing method of FIG. 13.

### DETAILED DESCRIPTION OF THE PREFERRED EMBODIMENT

Referring to the accompanying drawings, a method of manufacturing a thermal head according to an embodiment of the present invention is described below.

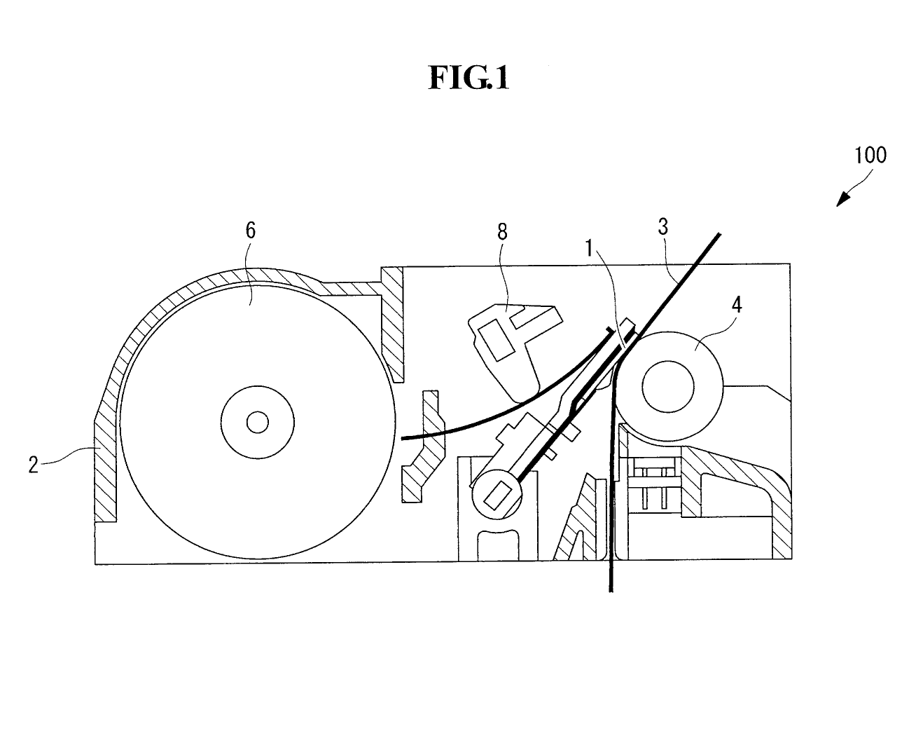

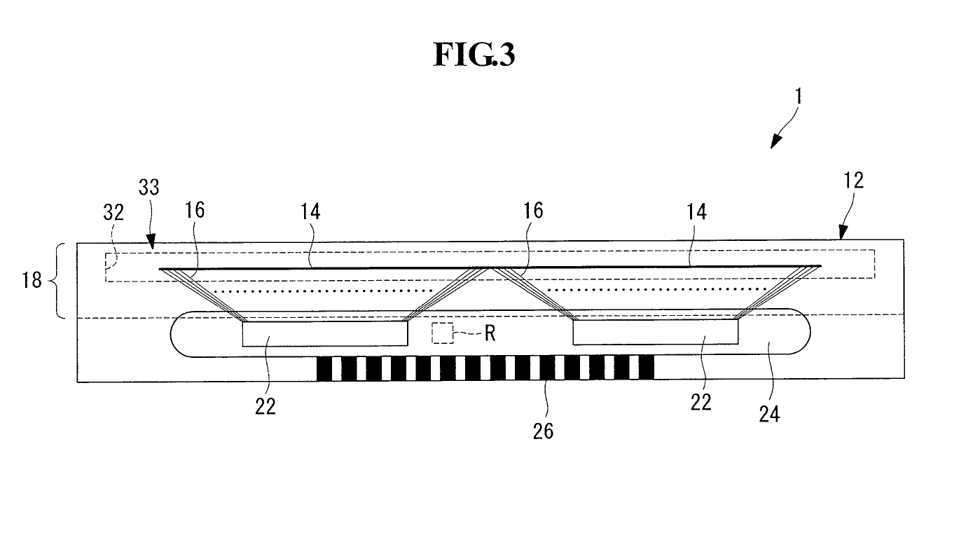

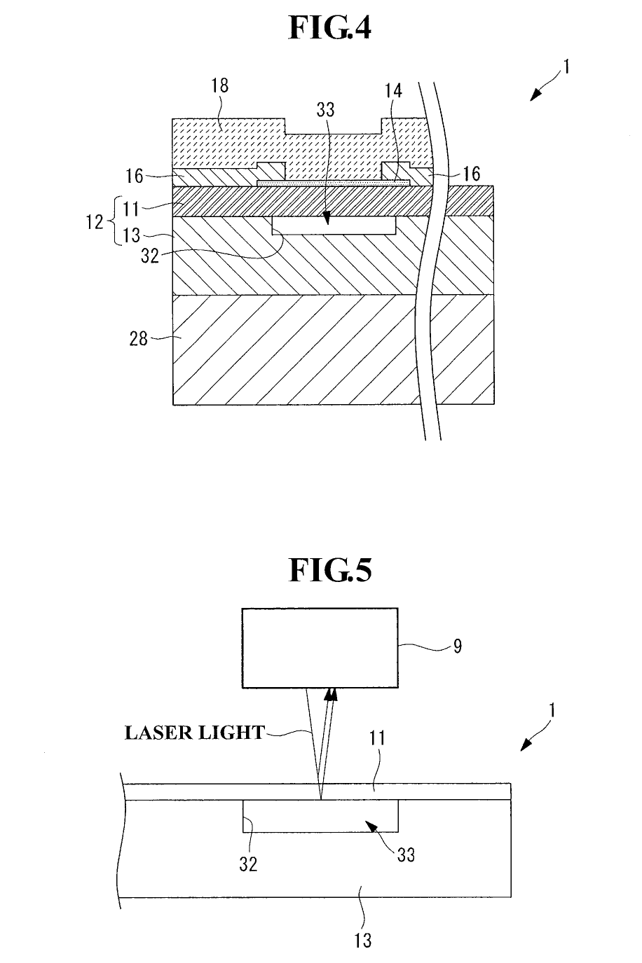

The method of manufacturing a thermal head according to this embodiment is intended for manufacturing a thermal head 1 (see FIGS. 3 and 4) to be used in a thermal printer 100 as illustrated in FIG. 1, for example.

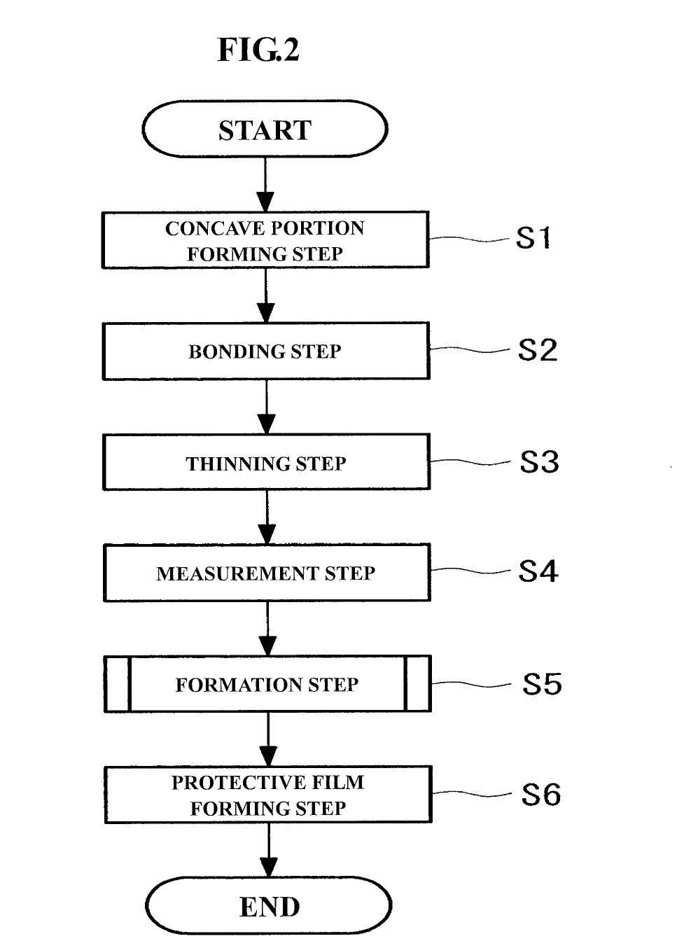

As illustrated in a flowchart of FIG. 2, the manufacturing method according to this embodiment includes a concave portion forming step S1 of forming a heat-insulating concave portion 32 opened in one surface of a flat support substrate 13, a bonding step S2 of bonding a flat upper substrate 11 onto the support substrate 13 having the heat-insulating concave portion 32 formed therein in a laminated state so as to close the heat-insulating concave portion 32, a thinning step S3 of thinning the upper substrate 11 bonded onto the support substrate 13, a measurement step S4 of measuring a thickness of the thinned upper substrate 11, a formation step S5 of forming an identifying resistor 35, a heating resistor 14, and an electrode wiring 16 which are to be described later, and a protective film forming step S6 of forming a protective film 18 for covering and protecting a part of the surface of the upper substrate 11 including the heating resistor 14 and the electrode wiring 16.

In FIG. 3, the heating resistor 14 is illustrated as a single straight line. Actually, however, a plurality of (such as 4,096) heating resistors 14 are arrayed at minute intervals in a longitudinal direction of a substrate main body 12.

The steps are specifically described below.

First, in the concave portion forming step S1, as the support substrate 13, an insulating glass substrate having a thickness of about 300 μm to about 1 mm is used. The rectangular heat-insulating concave portion 32 extending in a longitudinal direction of the support substrate 13 is formed in one surface of the support substrate 13 at a position opposed to the heating resistors 14 formed in the formation step S5.

The heat-insulating concave portion 32 can be formed by, for example, subjecting the one surface of the support substrate 13 to sandblasting, dry etching, wet etching, laser machining, or the like.

In the case where sandblasting is performed on the support substrate 13, the one surface of the support substrate 13 is covered with a photoresist material, and the photoresist material is exposed to light using a photomask of a predetermined pattern so as to be cured in part other than the region for forming the heat-insulating concave portion 32.

After that, the one surface of the support substrate 13 is cleaned and the uncured photoresist material is removed to obtain etching masks (not shown) having etching windows formed in the region for forming the heat-insulating concave portion 32. In this state, sandblasting is performed on the one surface of the support substrate 13 to form the heat-insulating concave portion 32 at a predetermined depth. It is preferred that the depth of the heat-insulating concave portion 32 be, for example, 10 μm or more and half or less of the thickness of the support substrate 13.

In the case where etching such as dry etching and wet etching is performed, as in the case of sandblasting, the etching masks having the etching windows formed in the region for forming the heat-insulating concave portion 32 are formed on the one surface of the support substrate 13. In this state, etching is performed on the one surface of the support substrate 13 to form the heat-insulating concave portion 32 at a predetermined depth.

As such an etching process, for example, wet etching using a hydrofluoric acid-based etchant or the like is available as well as dry etching such as reactive ion etching (RIE) and plasma etching. Note that, as a reference example, in the case of a single-crystal silicon support substrate, wet etching is performed using an etchant such as a tetramethylammonium hydroxide solution, a KOH solution, or a mixed solution of hydrofluoric acid and nitric acid.

Next, in the bonding step S2, the upper substrate 11 which is a glass substrate made of the same material as the support substrate 13 or a glass substrate having properties close to the material of the support substrate 13 is used. In this case, as the upper substrate 11, a substrate having a thickness of 100 μm or less is difficult to manufacture and handle, and is expensive. Thus, instead of directly bonding an originally thin upper substrate 11 onto the support substrate 13, the upper substrate 11 thick enough to be easily manufactured and handled is bonded onto the support substrate 13, and then the upper substrate 11 is processed by etching, polishing, or the like in the thinning step S3 so as to have a desired thickness.

First, all the etching masks are removed from the one surface of the support substrate 13, and the surface is cleaned. Then, the upper substrate 11 is attached onto the one surface of the support substrate 13 so as to close the heat-insulating concave portion 32. For example, the upper substrate 11 is attached directly onto the support substrate 13 without using any adhesive layer at room temperature.

When the one surface of the support substrate 13 is covered by the upper substrate 11, that is, an opening portion of the heat-insulating concave portion 32 is closed by the upper substrate 11, a heat-insulating cavity portion 33 is formed between the upper substrate 11 and the support substrate 13. In this state, the upper substrate 11 and the support substrate 13 attached together are subjected to heat treatment, to thereby bond the upper substrate 11 and the support substrate 13 by thermal fusion. The resultant substrate obtained by bonding the upper substrate 11 and the support substrate 13 together is hereinafter referred to as the substrate main body 12.

The heat-insulating cavity portion 33 has a communication structure opposed to all the heating resistors 14 formed on the layer thereabove. The heat-insulating cavity portion 33 functions as a hollow heat-insulating layer for preventing heat generated by the heating resistors 14 from transferring from the upper substrate 11 to the support substrate 13 side. Because the heat-insulating cavity portion 33 functions as the hollow heat-insulating layer, an amount of heat, which transfers in the direction toward the protective film 18 adjacent to one surface of the heating resistors 14, is increased to be more than an amount of heat, which transfers to the upper substrate 11 adjacent to the other surface of the heating resistors 14. Thermal paper 3 (see FIG. 1) is pressed against the protective film 18 during printing, and hence, when the amount of heat in this direction is increased, the amount of heat to be used for printing or the like is increased. Thus, use efficiency can be improved.

Next, in the thinning step S3, the upper substrate 11 bonded onto the support substrate 13 is processed by etching, polishing, or the like so as to have a desired thickness (for example, a thickness of about 10 μm to about 50 μm). In this way, the extremely thin upper substrate 11 can be formed on the one surface of the support substrate 13 easily at low cost.

As the etching of the upper substrate 11, various kinds of etching employable for forming the heat-insulating concave portion 32 as in the concave portion forming step S1 can be used. Further, as the polishing of the upper substrate 11, for example, chemical mechanical polishing (CMP) or the like, which is used for high precision polishing of a semiconductor wafer or the like, can be used.

In the measurement step S4, for example, light is radiated to a region of the upper substrate 11 opposed to the heat-insulating concave portion 32 of the support substrate 13, and based on the light reflected by the front surface and the rear surface of the upper substrate 11, the positions of the front surface and the rear surface are detected, to thereby measure the thickness of the upper substrate 11.

In this case, in the substrate main body 12 before the heating resistors 14 are formed, both the front surface of the upper substrate 11 opposed to the heat-insulating concave portion 32 and the rear surface thereof are in contact with air. That is, the front surface of the upper substrate 11 opposed to the heat-insulating concave portion 32 is exposed to the outside and is in contact with outside air, and the rear surface thereof is in contact with air inside the heat-insulating cavity portion 33 by closing the heat-insulating concave portion 32.

Therefore, for example, as illustrated in FIG. 5, when blue laser light is radiated to this region of the upper substrate 11, the blue laser light is reflected by each of the front surface and the rear surface of the upper substrate 11 due to the difference in refractive index between the upper substrate 11 and the air. Then, merely by detecting the reflected light reflected by each of the front surface and the rear surface of the upper substrate 11 by a sensor 9 or the like, the accurate thickness dimension of the upper substrate 11 can be optically measured even in the state where the upper substrate 11 and the support substrate 13 are bonded together.

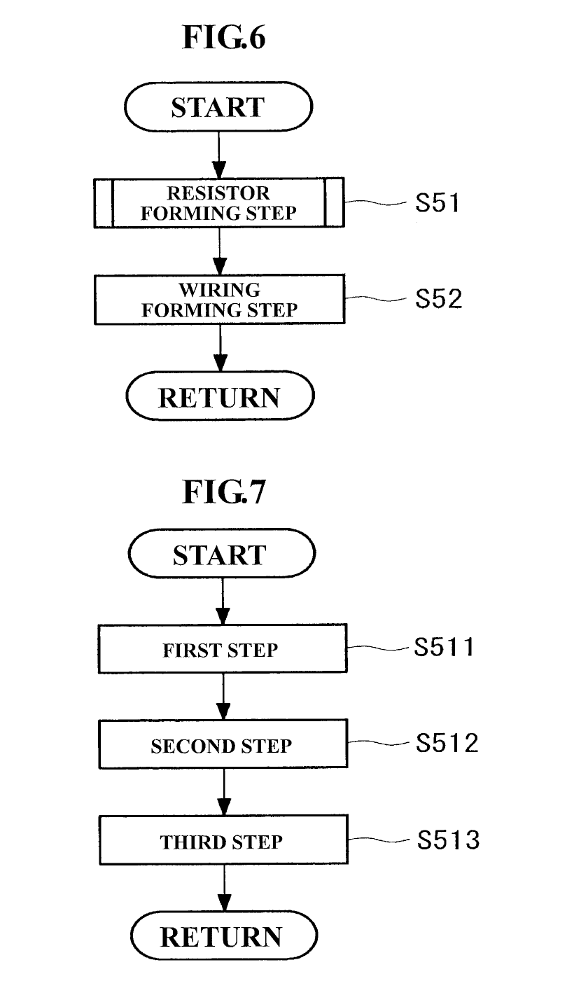

Next, as illustrated in FIG. 6, the formation step S5 includes a resistor forming step S51 of forming the identifying resistor 35 and the heating resistor 14, and a wiring forming step S52 of forming the electrode wiring 16 on both sides of the heating resistor 14 formed in the resistor forming step S51.

As illustrated in FIG. 7, the resistor forming step S51 includes a first step S511 of determining which group the thickness of the upper substrate 11 measured in the measurement step S4 belongs to and determining a pattern of an identifying concave portion 34, a second step S512 of forming the identifying concave portion 34 having the pattern determined in the first step S511 in the surface of the upper substrate 11 on which the identifying resistor 35 is to be formed, and a third step S513 of forming the identifying resistor 35 and the heating resistor 14.

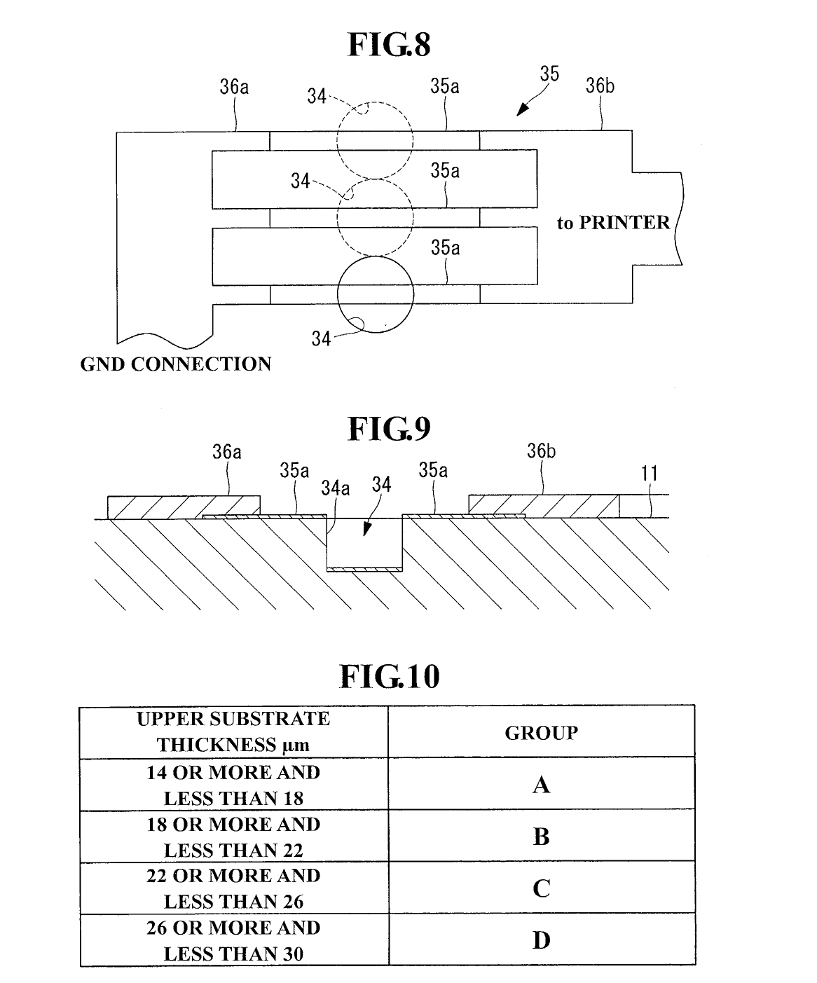

In the identifying resistor 35, as illustrated in FIG. 8 for example, a plurality of linear resistor pieces 35a having substantially the same resistance value are connected in parallel, and the identifying resistor 35 has one end connected to a grounded wiring 36a and the other end connected to a wiring 36b connected to a terminal 26 for connecting the identifying resistor 35 to the thermal printer 100. As illustrated in FIG. 3, the identifying resistor 35 is to be formed in any region on the upper substrate 11 of the thermal head 1 in which the other wirings 16 and the like are not arranged (for example, a region R). The number of resistor pieces 35a is determined based on the number of groups of the thickness of the upper substrate 11. For example, in the example illustrated in FIG. 8, the number of resistor pieces 35a is three, and the number of groups of the thickness of the upper substrate 11 is set to four.

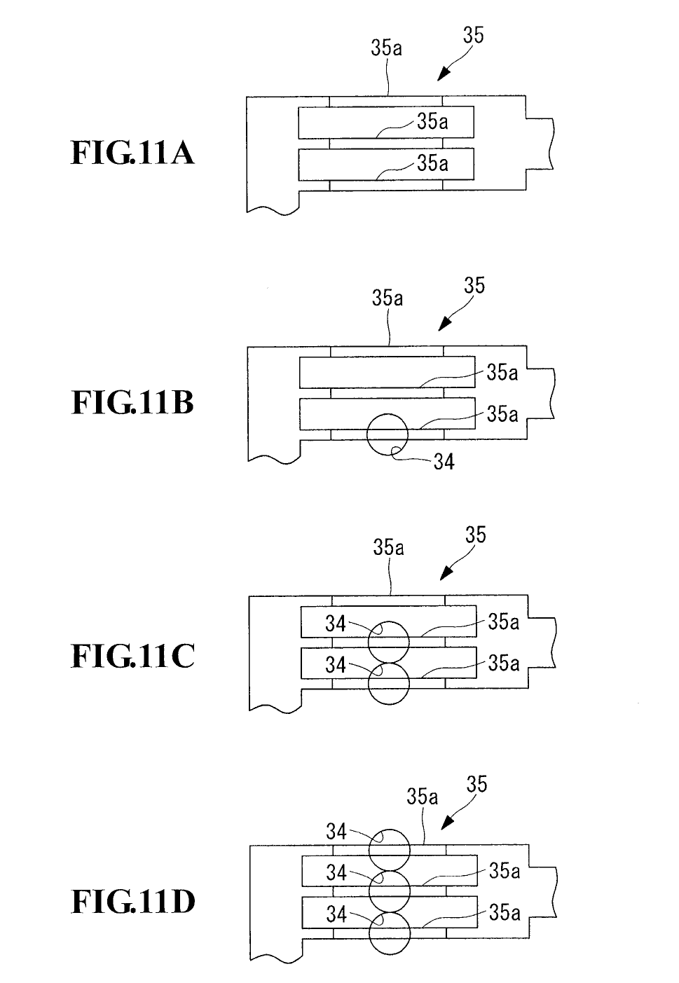

That is, the thickness of the upper substrate 11 is divided into four groups based on a table shown in FIG. 10. Then, when it is determined in the first step S511 that the thickness of the upper substrate 11 belongs to the groups A, B, C, and D, the pattern of the identifying concave portion 34 is determined as the patterns illustrated in FIGS. 11A, 11B, 11C, and 11D, respectively. In FIG. 8, the identifying concave portion 34 is indicated by a solid line, and broken lines indicate the positions at which the identifying concave portions 34 are intended to be formed. The pattern of FIG. 11A has no solid line, and no identifying concave portion 34 is formed.

As illustrated in FIG. 9, the identifying concave portion 34 is a recess obtained by scraping off the surface of the upper substrate 11 by cutting or the like, and includes an inner wall 34a discontinuously connected to the surface of the upper substrate 11. It is preferred that an angle of the inner wall 34a be orthogonal to the surface of the upper substrate 11 as illustrated in FIG. 9. However, the angle is not necessarily orthogonal to the surface of the upper substrate 11. The inner wall 34a only needs to have such a shape or angle that the resistor piece 35a made of a thin film, which is formed so as to cross the identifying concave portion 34 in the subsequent third step S513, is cut by an edge of the identifying concave portion 34. Further, the identifying concave portion 34 may be formed of a through hole.

The heating resistors 14 are each formed on the surface of the upper substrate 11 so as to straddle the heat-insulating cavity portion 33 in its width direction, and are arrayed at predetermined intervals in the longitudinal direction of the heat-insulating cavity portion 33. In this embodiment, a heating resistor having a predetermined resistance value is formed.

In the third step S513, the identifying resistor 35 and the heating resistor 14 are formed simultaneously. These resistors can be formed by a thin film formation method such as sputtering, chemical vapor deposition (CVD), or vapor deposition. A thin film of a heating resistor material such as a Ta-based thin film or a silicide-based thin film is formed on the upper substrate 11. The thin film is then patterned by lift-off, etching, or the like to form the identifying resistor 35 and the heating resistor 14 having a desired shape.

Subsequently, in the wiring forming step S52, similarly to the third step S513 of the resistor forming step S51, a film of a wiring material such as Al, Al—Si, Au, Ag, Cu, or Pt is formed on the upper substrate 11 by sputtering, vapor deposition, or the like. Then, the film thus obtained is patterned by lift-off or etching, or alternatively the wiring material is baked after screen-printing, to thereby form the electrode wiring 16.

The electrode wiring 16 includes individual electrode wirings connected to one ends of the respective heating resistors 14 in the direction orthogonal to the array direction of the identifying resistor and the respective heating resistors 14, and a common electrode wiring connected integrally to the other ends of all the heating resistors 14. Note that, the order of forming the heating resistors 14 and the electrode wiring 16 is optional. In pattering of a resist material for the lift-off or etching of the heating resistors 14 and the electrode wiring 16, a photomask is used to pattern the photoresist material.

Next, in the protective film forming step S6, on the upper substrate 11 having the identifying resistor, the heating resistors 14, and the electrode wiring 16 formed thereon, a film of a protective film material such as SiO₂, Ta₂O₅, SiAlON, Si₃N₄, or diamond-like carbon is formed by sputtering, ion plating, CVD, or the like, to thereby form the protective film 18. With the protective film 18 thus formed, the heating resistors 14 and the electrode wiring 16 can be protected from abrasion and corrosion.

On the surface of the upper substrate 11, for example, there are further formed a drive IC 22 electrically connected to each heating resistor 14 via the electrode wiring 16, an IC resin coating film 24 for covering the drive IC 22 for protection from abrasion and corrosion, and a plurality of (such as about 10) terminals 26 for supplying electric power energy to the heating resistors 14 and exchanging signals between the terminals 26 and the thermal printer. The drive IC 22, the IC resin coating film 24, and the terminals 26 can be formed by using a known manufacturing method for the conventional thermal head.

The drive IC 22 controls heating operations of the heating resistors 14 individually, and is capable of driving a selected heating resistor 14 while controlling the voltage applied thereto via the individual electrode wiring. On the upper substrate 11, two drive ICs 22 are arranged at an interval along the array direction of the heating resistors 14, and one-half of the heating resistors 14 are connected to each drive IC 22 via the individual electrode wirings.

Through the steps described above, the thermal head 1 illustrated in FIGS. 3 and 4 is manufactured. The thermal head 1 manufactured in this way can be fixed to a heat sink plate 28 as a plate member made of a metal such as aluminum, a resin, ceramics, glass, or the like. With this, heat of the thermal head 1 is dissipated via the heat sink plate 28.

Further, the thermal head 1 can be used in the thermal printer 100 including a main body frame 2, a platen roller 4 disposed horizontally, the thermal head 1 disposed opposite to an outer peripheral surface of the platen roller 4, a paper feeding mechanism 6 for feeding an object to be printed, such as the thermal paper 3, between the platen roller 4 and the thermal head 1, and a pressure mechanism 8 for pressing the thermal head 1 against the thermal paper 3 with a predetermined pressing force.

In the thermal printer 100, the thermal head 1 and the thermal paper 3 are pressed against the platen roller 4 by the operation of the pressure mechanism 8. When a voltage is selectively applied to the individual electrode wirings by the drive IC 22, a current flows through the heating resistor 14 which is connected to the selected individual electrode wiring, and this heating resistor 14 generates heat. In this state, the pressure mechanism 8 operates to press the thermal paper 3 against a surface portion (printing portion) of the protective film 18 covering heating portions of the heating resistors 14, and then color is developed on the thermal paper 3 to be printed.

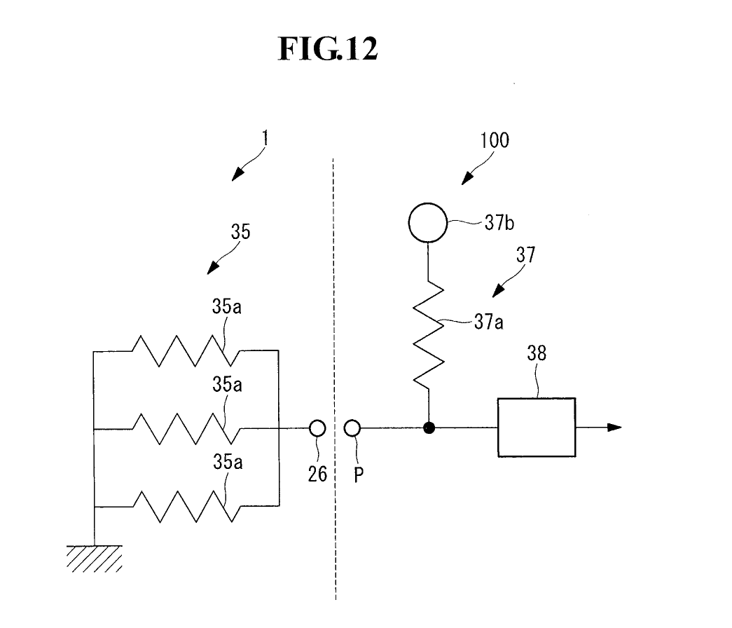

Further, the thermal printer 100 is provided with a detection circuit 37 and an adjustment section 38 for adjusting a voltage to be supplied to the thermal head 1 based on a voltage value detected by the detection circuit 37 as illustrated in FIG. 12.

As illustrated in FIG. 12, the detection circuit 37 includes a reference resistor 37a having one end connected to the terminal 26 of the thermal head 1 and a power source 37b connected to the other end of the reference resistor 37a in the state where the thermal head 1 is mounted in the thermal printer 100. The power source 37b is a constant voltage power source. Utilizing that a voltage at a terminal P connected to the terminal 26 changes in accordance with the resistance value of the identifying resistor 35 connected to the one end of the reference resistor 37a, the thickness of the upper substrate 11 of the thermal head 1 can be recognized easily from the thermal printer 100 side.

Further, because the groups A to D of the thickness of the upper substrate 11 are recognized based on the voltage at the terminal P, the adjustment section 38 sets a voltage corresponding to the recognized group and supplies the voltage to the thermal head 1. Specifically, the heating efficiency is lowered as the upper substrate 11 becomes thicker, and hence the adjustment section 38 increases the voltage to be supplied to the thermal head 1 so as to compensate for the lowered heating efficiency, and on the other hand, the heating efficiency is increased as the upper substrate 11 becomes thinner, and hence the adjustment section 38 decreases the voltage to be supplied to the thermal head 1 so as to suppress the increased heating efficiency.

As described above, according to the method of manufacturing the thermal head 1 of this embodiment, the upper substrate 11 having the heating resistors 14 formed on the surface thereof functions as a heat storage layer. Accordingly, when the upper substrate 11 is thinned in the thinning step S3, the heat capacity as the heat storage layer can be reduced to suppress the amount of heat that dissipates to the upper substrate 11 side among the amount of heat generated by the heating resistors 14. Thus, the available amount of heat can be increased.

In this case, the available amount of heat depends on the thickness of the upper substrate 11 thinned in the thinning step S3. However, the identifying resistor 35 is formed so that the group of the thickness of the thinned upper substrate 11 measured in the measurement step S4 can be recognized from the thermal printer 100 side. Therefore, the variation in printing density of the thermal printer 100 can be suppressed irrespective of the thickness of the thinned upper substrate 11.

Therefore, it is possible to easily manufacture the highly-efficient thermal head 1 capable of accurately outputting a target heating amount that takes into account the amount of heat which is not utilized and wasted.

Note that, in this embodiment, in the measurement step S4, the thickness of the upper substrate 11 is measured optically. Alternatively, however, for example, the thickness of the support substrate 13 may be measured in advance before the bonding step S2, and in the measurement step S4, the thickness of the upper substrate 11 may be calculated by subtracting the thickness dimension of the support substrate 13 from the thickness dimension of the thinned substrate main body 12.

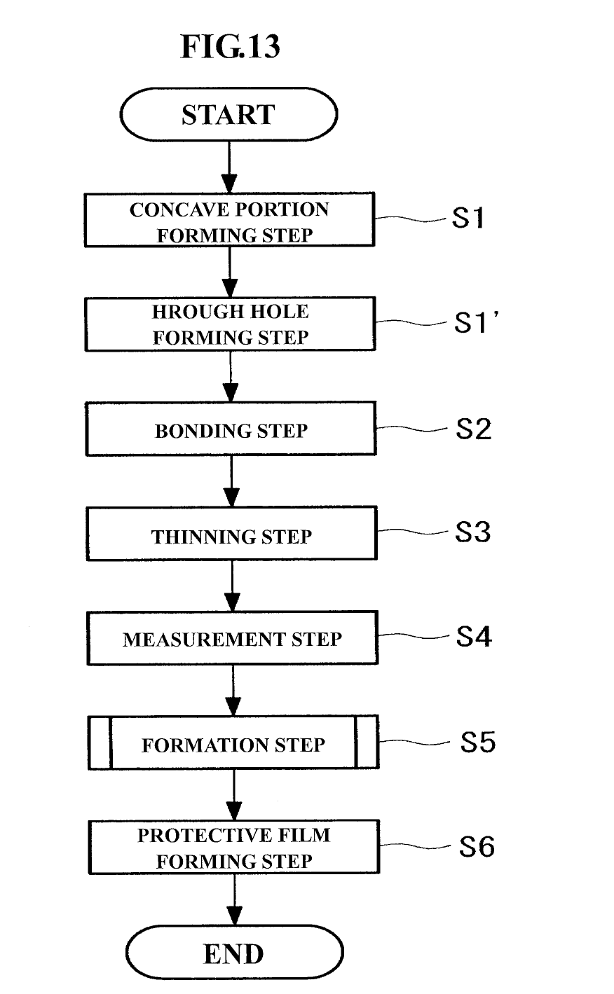

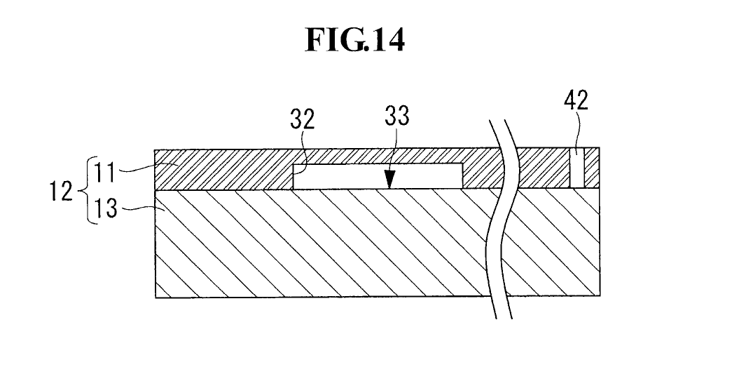

Further, for example, as illustrated in a flowchart of FIG. 13, the manufacturing method may include, before the bonding step S2, a through hole forming step S1′ of forming a through hole 42 (see FIG. 14) passing through the upper substrate 11 in the thickness direction at a position at which the heating resistor 14 is not formed. Then, in the bonding step S2, the upper substrate 11 and the support substrate 13 may be bonded together so that one end of the through hole 42 is closed by the one surface of the support substrate 13, and in the measurement step S4, the depth of the through hole 42 of the upper substrate 11 bonded onto the support substrate 13 may be measured.

With this configuration, even in the state where the upper substrate 11 and the support substrate 13 are bonded together, for example, only the thickness of the upper substrate 11 can be measured by measuring the depth of the through hole 42 while inserting a measuring instrument such as a micrometer into the through hole 42. The through hole 42 may be formed in the concave portion forming step S1 similarly and simultaneously with the formation of the heat-insulating concave portion 32.

Hereinabove, the embodiment of the present invention has been described in detail with reference to the accompanying drawings. However, specific configurations of the present invention are not limited to the embodiment, and include design modifications and the like without departing from the gist of the present invention.

For example, the present invention is not particularly limited to the above-mentioned embodiment and modified example, and may be applied to an embodiment in an appropriate combination of the embodiment and modified example.

Further, in the above-mentioned embodiment, the heat-insulating concave portion 32 provided in the surface on the support substrate 13 side has been exemplified as the heat-insulating concave portion 32. Alternatively, however, the heat-insulating concave portion 32 may be provided on the upper substrate side, or may be formed of, for example, a through hole passing through the support substrate 13 in the thickness direction.

What is claimed is:

1. A method of manufacturing a thermal head, comprising:
bonding a support substrate and an upper substrate, which have a flat shape, together in a laminated state, the support substrate and the upper substrate having opposed surfaces, at least one of which includes a heat-insulating concave portion;
thinning the upper substrate bonded onto the support substrate in the bonding;
measuring a thickness of the upper substrate thinned in the thinning;
forming an identifying resistor having a resistance value varied in accordance with the thickness of the upper substrate measured in the measuring, the identifying resistor including one end grounded; and
forming a heating resistor on a surface of the upper substrate thinned in the thinning at a position opposed to the heat-insulating concave portion.

2. A method of manufacturing a thermal head according to claim 1, wherein the forming an identifying resistor comprises:
forming a thin film as a linear resistor piece which has a predetermined resistance value; and
forming an identifying concave portion in a region to be crossed by the linear resistor piece,
the identifying concave portion being recessed from the surface of the upper substrate with a pattern varied in accordance with a group of the thickness of the upper substrate measured in the measuring,
the forming an identifying concave portion preceding the forming a thin film.

3. A method of manufacturing a thermal head according to claim 2, wherein the forming a thin film comprises forming the linear resistor pieces having substantially the same resistance value in parallel in a number smaller than a number of the groups of the thickness of the upper substrate by at least one.

4. A method of manufacturing a thermal head according to claim 2, wherein the forming a thin film and the forming a heating resistor are performed simultaneously.

5. A method of manufacturing a thermal head according to claim 3, wherein the forming a thin film and the forming a heating resistor are performed simultaneously.

6. A method of manufacturing a thermal head according to claim 1, further comprising forming a through hole in the upper substrate thinned in the thinning, the through hole passing through the upper substrate in a thickness direction of the upper substrate,
wherein the measuring comprises measuring a depth of the through hole formed in the forming a through hole.

7. A method of manufacturing a thermal head according to claim 5, further comprising forming a through hole in the upper substrate thinned in the thinning, the through hole passing through the upper substrate in a thickness direction of the upper substrate,
wherein the measuring comprises measuring a depth of the through hole formed in the forming a through hole.

8. A thermal printer, which is connected to a thermal head manufactured by the method of manufacturing a thermal head according to claim 1,
the thermal printer comprising a detection circuit for detecting a resistance value of an identifying resistor included in the thermal head.

9. A thermal printer, which is connected to a thermal head manufactured by the method of manufacturing a thermal head according to claim 7,
the thermal printer comprising a detection circuit for detecting a resistance value of an identifying resistor included in the thermal head.

10. A thermal printer according to claim 8, further comprising a control section for controlling a current to be supplied to the thermal head in accordance with the resistance value of the identifying resistor detected by the detection circuit.

11. A thermal printer according to claim 9, further comprising a control section for controlling a current to be supplied to the thermal head in accordance with the resistance value of the identifying resistor detected by the detection circuit.

12. A method of driving a thermal printer, comprising controlling a current to be supplied to the thermal head in accordance with the resistance value of the identifying resistor detected by the detection circuit of the thermal printer according to claim 8.

13. A method of driving a thermal printer, comprising controlling a current to be supplied to the thermal head in accordance with the resistance value of the identifying resistor detected by the detection circuit of the thermal printer according to claim 9.
